(19) United States
(12) Patent Application Publication
(10) Pub. No.: US 2018/0121295 A1
(43) Pub. Date: May 3, 2018

(54) Backup Optimization Based Dynamic Resource Feedback

(71) Applicant: Huawei Technologies Co., Ltd, Shenzhen (CN)

(72) Inventors: Prasanna Venkatesh RAMAMURTHI, Bangalore (IN); Vamsi Krishna, Bangalore (IN)

(21) Appl. No.: 15/699,564

(22) Filed: Sep. 8, 2017

Related U.S. Application Data
(63) Continuation of application No. PCT/CN2017/083502, filed on May 8, 2017.

(30) Foreign Application Priority Data
Oct. 31, 2016 (IN) IN201641037278

(51) Int. Cl. G06F 11/14

(52) U.S. Cl. CPC G06F 11/1458; G06F 2201/81

(57) ABSTRACT

A method for backing up data in a database system relates to dynamically monitoring usage of resources such as central processing unit (CPU), memory, and network bandwidth in order to utilize them in an optimal manner in the backup process, based on the current usage of resources. A resource monitoring subsystem is configured to monitor the usage of network, CPU and memory on a server, on which both the database and backup/restoring process of data is in progress.

### CROSS-REFERENCE TO RELATED APPLICATIONS

This application is a continuation of International Patent Application No. PCT/CN2017/083502 filed on May 8, 2017, which claims priority to Indian Patent Application No. IN201641037278 filed on Oct. 31, 2016. The disclosures of the aforementioned applications are hereby incorporated by reference in their entireties.

### TECHNICAL FIELD

The field of the present disclosure pertains to optimal backup of data in a database system. In particular, the disclosure relates to optimal utilization and control of resources for optimal backup of data in the database system.

### BACKGROUND

In a database system, backup of data and restoring data is significant to support highly available database systems. The information is stored locally or is backed up on continuous intervals to avoid data loss. Backup of data is provided by taking a copy of the needed data, either data files or user data, to a storage medium. When a database needs to be restored, the data is transferred back from the storage medium to a database server such that the data becomes accessible in case of data loss at any time in future.

Commonly, data may be transferred to and from storage medium over the network and during this transfer, network bandwidth becomes a concern. The amount of time consumed in the backup process is usually based on various factors, including the type of backup process such as online backup, raw data backup, file system backup, snapshot backup, etc., the type of input/output (IO) such as buffered Input-Output or un-buffered Input-Output, system properties including speed, memory size, etc. or the amount of data to be processed.

Resources such as central processing unit (CPU) and memory are utilized as part of the backup process. The CPU used by backup process is idle when the network transmission is going on. If the backup data is to be compressed as per policy and the database server is over-occupied, then the limitation is that the backup and database are bound to compete for CPU utilization, which results in usage of resources based on a pre-configured policy. Hence, the current utilization of resources is not considered.

### SUMMARY

In order to provide optimal backup of data in a database system, the present application provides dynamic monitoring of usage of resources, and building some intelligent decisions for backup and restoration of data based on the monitored statistics of current usage of resources. The application is applicable wherever resource utilization varies dynamically based on different work load conditions and where it is difficult for a user to configure the optimal resource utilization statically.

The resources include CPU, memory and network bandwidth. A resource monitoring subsystem is configured to monitor the usage of CPU and memory on the server on which the database and backup/restore operation are in progress.

In an embodiment of the present application disclosure, a method for backing up data in a database system, is disclosed. The method comprises monitoring at least one usage status of the database system, backing up the data by a first backup method, and backing up the data by a second backup method when the monitored usage status meets a preset condition, wherein the second backup method is different from the first backup method.

According to another embodiment, the usage status comprises CPU utilization, and backing up the data using a first backup method, and backing up the data using a second backup method when the monitored usage status meets a preset condition include backing up the data using an uncompressed mode, wherein the uncompressed mode presents the uncompressed data during the backing up, and backing up the data using a compressed mode when CPU utilization is lower than a first threshold, wherein the compressed mode presents the data is compressed during the backing up, or backing up the data using the compressed mode, and backing up the data using the uncompressed mode when CPU utilization is higher than a second threshold, or backing up the data with a first data accessing rate, and backing up the data with a second data accessing rate when CPU utilization is lower than a third threshold, wherein the second data accessing rate is higher than the first data accessing rate, or backing up the data with the second data accessing rate, backing up the data with the first data accessing rate when CPU utilization is higher than a fourth threshold.

According to yet another embodiment of the present application, the usage status includes memory utilization, and backing up the data using a first backup method, and backing up the data using a second backup method when the monitored usage status meets a preset condition include backing up the data using an uncompressed mode, wherein the uncompressed mode presents uncompressed data during the backing up, and backing up the data using a compressed mode when memory utilization is lower than a first threshold, wherein the compressed mode presents the data is compressed during the backing up, or backing up the data using the compressed mode, and backing up the data using the uncompressed mode when memory utilization is higher than a second threshold, or backing up the data with a first data accessing rate, and backing up the data with a second data accessing rate when memory utilization is lower than a third threshold, wherein the second data accessing rate is higher than the first data accessing rate, or backing up the data with the second data accessing rate, and backing up the data with the first data accessing rate when memory utilization is higher than a fourth threshold.

According to yet another embodiment of the present application, the usage status includes network utilization, and backing up the data using a first backup method, and backing up the data using a second backup method when the monitored usage status meets a preset condition include backing up the data using an uncompressed mode, wherein the uncompressed mode presents the uncompressed data during the backing up, and backing up the data using a compressed mode when network utilization is lower than a first threshold, wherein the compressed mode presents the data is compressed during the backing up, or backing up the data using the compressed mode, and backing up the data using the uncompressed mode when network utilization is higher than a second threshold, or backing up the data with a first data accessing rate, and backing up the data with a second data accessing rate when network utilization is lower than a third threshold, wherein the second data accessing rate is higher than the first data accessing rate, or backing up the data with the second data accessing rate, and backing up the data with the first data accessing rate when network utilization is higher than a fourth threshold.

According to still another embodiment of the present application, wherein before monitoring at least one usage status of the database system, the method includes adjusting the preset condition.

According to an embodiment of the present application, a database system for backing up data, including a server and a usage status monitor coupled to the server, where the usage status monitor configured to monitor at least one usage status of the database system. The server is configured to back up the data using a first backup method, and back up the data using a second backup method when the monitored usage status meets a preset condition, wherein the second backup method is different from the first backup method.

According to yet another embodiment of the application, the server comprises a CPU and a memory coupled to the CPU, wherein the CPU is configured to back up the data using a first backup method, and backing up the data using a second backup method when the monitored usage status meets a preset condition.

According to yet another embodiment of the application, the database system comprising an external storage device, the external storage device connects with the server by a network. The external storage device is configured to store the data to be backed up.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 is an illustration of a flow diagram of a resource monitor subsystem according to an embodiment of the present application disclosure.

FIG. 2 is an illustration of a diagram of a resource optimization system according to an embodiment of the present application disclosure.

### DESCRIPTION OF EMBODIMENTS

The following discussion provides a brief, general description of a suitable computing environment in which various embodiments of the present disclosure can be implemented. The aspects and embodiments are described in the general context of computer executable mechanisms such as routines executed by a handheld device e.g. a mobile phone, a personalized digital assistant, a cellular device, a tablet et al. The embodiments described herein can be practiced with other system configurations, including Internet appliances, hand held devices, multi-processor systems, microprocessor based or programmable consumer electronics, network personal computers (PCs), mini computers, mainframe computers and the like. The embodiments can be embodied in a special purpose computer or data processor programmed, configured or constructed to perform one or more of the computer executable mechanisms explained in detail below.

Exemplary embodiments now will be described with reference to the accompanying drawings. The disclosure may, however, be embodied in many different forms and should not be construed as limited to the embodiments set forth herein, rather, these embodiments are provided such that this disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections, the actual physical connections may be different. It is apparent to a person skilled in the art that the structure may also comprise other functions and structures. It should be appreciated that the functions, structures, elements and the protocols used in communication are irrelevant to the present disclosure. Therefore, they need not be discussed in further detail here.

In addition, all logical units described and depicted in the figures include the software and/or hardware components needed for the unit to function. Further, each unit may comprise within itself one or more components, which are implicitly understood. These components may be operatively coupled to each other and be configured to communicate with each other to perform the function of the said unit.

The present application deals with dynamically monitoring usage of resources such as CPU, memory, and network bandwidth in order to intelligently decide and utilize them in an optimal manner, based on the current usage of resources. A resource monitoring subsystem monitors the usage of CPU and memory on the server, on which both the database and backup/restoring process of data is in progress.

The threshold levels for resource usage are configured both for high level and low level. There are two types of backup when the backup process is configured in uncompressed mode and CPU usage is low, then resource monitoring subsystem triggers the compression automatically to reduce the data size but increases the CPU utilization, hence the reduced data size in turn helps fasten the network transmission.

When the backup process is configured in compressed mode and CPU usage is high, then resource monitoring subsystem automatically reconfigures the compression policy so that the CPU utilization reduces.

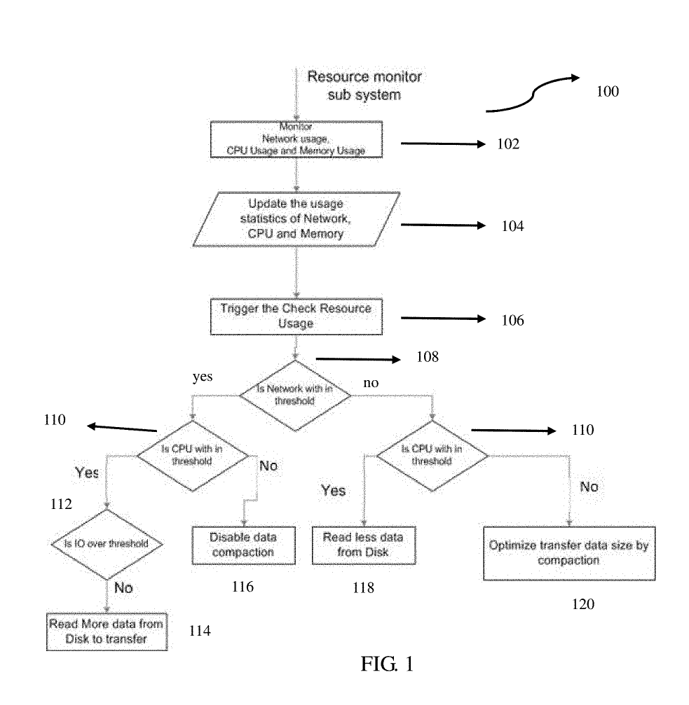

FIG. 1 illustrates a flow diagram 100 showing working of a resource monitor subsystem according to an embodiment of the present disclosure. In step 102, the network usage, CPU usage and memory usage is monitored at one point of time. After regular intervals, the usage statistics of network, CPU and memory are updated in step 104. Then, a check on resource usage is triggered in step 106. In step 108, it is determined if the network usage is within threshold level. If the network usage is less than the threshold level, then step 110 is performed to check CPU usage. If CPU usage is within threshold level, the IO level is determined in step 112 to check if it is over threshold. If the IO level is not over threshold, more data is read from disk to transfer in step 114.

On the other hand, if CPU usage is more than threshold level, data compaction is disabled in step 116. According to an embodiment of the application, if the network usage is more than the threshold level, the same step 110 of checking CPU usage is performed. If the CPU usage is within threshold (more than threshold in this case), less data is read from the disk in step 118. If the CPU usage is not within threshold (less than threshold in this case), then the transfer data size is optimized by compaction in step 120.

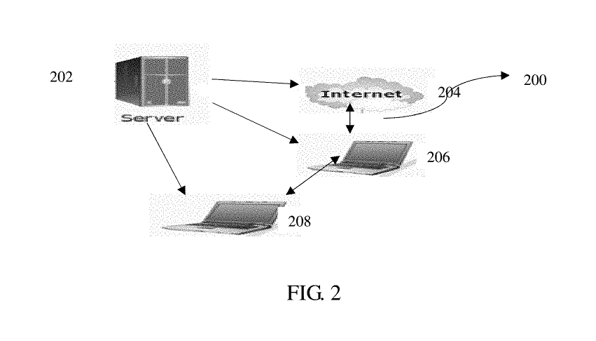

FIG. 2 illustrates a diagram of a resource optimization system 200 according to an embodiment of the present application. The resource optimization system 200 comprises a server 202. According to an embodiment, the server 202 is connected to resources such as network 204, CPU 206 and memory 208, for receiving the statistics of utilization of each of these resources. The network 204 usage is measured in terms of network bandwidth and it may be a wireless network or internet, memory 208 may include any or similar storage device implemented in the known art.

The CPU 206 utilization may be determined to check load on the processor i.e. for how much time the processor remains idle and for how much time the processor is loaded and the load is computed in terms of percentage.

The benefits provided by this application include that the utilization of resources can be controlled automatically based on dynamic usage measurements. The application is a step towards self-manageability of the backup/restore subsystem.

The aforementioned description of the embodiments of the application has been presented for the purposes of illustration and description. It is not intended to be exhaustive or to limit the application to the precise form disclosed. Many modifications and variations are possible in light of the above teaching. It is intended that the scope of the application be limited not by this detailed description, rather by the claims appended hereto.

As will be appreciated by one skilled in the art, the present application may be embodied as a method, system, or computer program product. Accordingly, the present application may take the form of an entirely hardware embodiment, a software embodiment or an embodiment combining software and hardware aspects all generally referred to herein as a “circuit” or “module.” Furthermore, the present application may take the form of a computer program product on a computer-usable storage medium having computer-usable program code embodied in the medium.

It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Instructions may also be loaded onto a computer or other programmable data processing apparatus like a scanner/check scanner to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

In the drawings and specification, there have been disclosed exemplary embodiments of the application. Although specific terms are employed, they are used in a generic and descriptive sense only and not for purposes of limitation, the scope of the application being defined by the following claims.

What is claimed is:

1. A method for backing up data in a database system, comprising:
monitoring at least one usage status of the database system;
backing up the data using a first backup method; and
backing up the data using a second backup method when the monitored at least one usage status meets a preset condition, and
wherein the second backup method is different from the first backup method.

2. The method according to claim 1, wherein the at least one usage status comprises central processing unit (CPU) utilization, wherein backing up the data using the first backup method, and backing up the data using the second backup method comprises:
backing up the data using an uncompressed mode, wherein the uncompressed mode presents uncompressed data during the backing up; and
backing up the data using a compressed mode when the CPU utilization is lower than a first threshold, and
wherein the compressed mode presents compressed data during the backing up.

3. The method according to claim 1, wherein the at least one usage status comprises central processing unit (CPU) utilization, wherein backing up the data using the first backup method, and backing up the data using the second backup method comprises:
backing up the data using a compressed mode, wherein the compressed mode presents compressed data during the backing up; and
backing up the data using an uncompressed mode when the CPU utilization is higher than a second threshold, and
wherein the uncompressed mode presents uncompressed data during the backing up.

4. The method according to claim 1, wherein the at least one usage status comprises central processing unit (CPU) utilization, wherein backing up the data using the first backup method, and backing up the data using the second backup method comprises:
backing up the data with a first data accessing rate; and
backing up the data with a second data accessing rate when the CPU utilization is lower than a third threshold, and
wherein the second data accessing rate is higher than the first data accessing rate.

5. The method according to claim 1, wherein the at least one usage status comprises central processing unit (CPU) utilization, wherein backing up the data using the first backup method, and backing up the data using the second backup method comprises:
backing up the data with a second data accessing rate; and
backing up the data with a first data accessing rate when the CPU utilization is higher than a fourth threshold, and
wherein the second data accessing rate is higher than the first data accessing rate.

6. The method according to claim 1, wherein the at least one usage status includes memory utilization, wherein backing up the data using the first backup method, and backing up the data using the second backup method comprises:
backing up the data using an uncompressed mode, wherein the uncompressed mode presents uncompressed data during the backing up; and
backing up the data using a compressed mode when the memory utilization is lower than a first threshold, and
wherein the compressed mode presents compressed data during the backing up.

7. The method according to claim 1, wherein the at least one usage status includes memory utilization, wherein backing up the data using the first backup method, and backing up the data using the second backup method comprises:
backing up the data using a compressed mode, wherein the compressed mode presents compressed data during the backing up; and
backing up the data using an uncompressed mode when the memory utilization is higher than a second threshold, and
wherein the uncompressed mode presents uncompressed data during the backing up.

8. The method according to claim 1, wherein the at least one usage status includes memory utilization, wherein backing up the data using the first backup method, and backing up the data using the second backup method comprises:
backing up the data with a first data accessing rate; and
backing up the data with a second data accessing rate when the memory utilization is lower than a third threshold, and
wherein the second data accessing rate is higher than the first data accessing rate.

9. The method according to claim 1, wherein the at least one usage status includes memory utilization, wherein backing up the data using the first backup method, and backing up the data using the second backup method comprises:
backing up the data with a second data accessing rate; and
backing up the data with a first data accessing rate when the memory utilization is higher than a fourth threshold, and
wherein the second data accessing rate is higher than the first data accessing rate.

10. The method according to claim 1, wherein the at least one usage status includes network utilization, wherein backing up the data using the first backup method, and backing up the data using the second backup method comprises:
backing up the data using an uncompressed mode, wherein the uncompressed mode presents uncompressed data during the backing up; and
backing up the data using a compressed mode when the network utilization is lower than a first threshold, and
wherein the compressed mode presents compressed data during the backing up.

11. The method according to claim 1, wherein the at least one usage status includes network utilization, wherein backing up the data using the first backup method, and backing up the data using the second backup method comprises:
backing up the data using a compressed mode, wherein the compressed mode presents compressed data during the backing up; and
backing up the data using an uncompressed mode when the network utilization is higher than a second threshold, and
wherein the uncompressed mode presents uncompressed data during the backing up.

12. The method according to claim 1, wherein the at least one usage status includes network utilization, wherein backing up the data using the first backup method, and backing up the data using the second backup method comprises:
backing up the data with a first data accessing rate; and
backing up the data with a second data accessing rate when the network utilization is lower than a third threshold, and
wherein the second data accessing rate is higher than the first data accessing rate.

13. The method according to claim 1, wherein the at least one usage status includes network utilization, wherein backing up the data using the first backup method, and backing up the data using the second backup method comprises:
backing up the data with a second data accessing rate; and
backing up the data with a first data accessing rate when the network utilization is higher than a fourth threshold, and
wherein the second data accessing rate is higher than the first data accessing rate.

14. The method according to claim 1, wherein before monitoring the at least one usage status of the database system, the method further comprises adjusting the preset condition.

15. A database system for backing up data, comprising:
a server; and
a usage status monitor coupled to the server,
wherein the usage status monitor is configured to monitor at least one usage status of the database system, and
wherein the server is configured to:
back up the data using a first backup method; and
back up the data using a second backup method when the monitored at least one usage status meets a preset condition, and
wherein the second backup method is different from the first backup method.

16. The database system according to claim 15, wherein the server comprises:
a central processing unit (CPU); and
a memory coupled to the CPU,
wherein the CPU is configured to:
back up the data using the first backup method; and
back up the data using the second backup method when the monitored at least one usage status meets the preset condition.

17. The database system according to claim 15, further comprising an external storage device, wherein the external storage device connects with the server using a network, and wherein the external storage device is configured to store to-be back up data.

18. A database system for backing up data, comprising:
a processor;
a memory coupled to the processor; and
a monitor coupled to the processor,
wherein the monitor is configured to monitor at least one usage status of the database system, and
wherein the processor is configured to:
back up the data using a first backup method; and
back up the data using a second backup method when the monitored at least one usage status meets a preset condition, and
wherein the second backup method is different from the first backup method.
